(19) United States
(12) Patent Application Publication
(10) Pub. No.: US 2023/0339094 A1
(43) Pub. Date: Oct. 26, 2023

(54) AGILE CLEANING DEVICE

(71) Applicant: Naji Chamieh, Plano, TX (US)

(72) Inventor: Naji Chamieh, Plano, TX (US)

(21) Appl. No.: 17/727,779

(22) Filed: Apr. 24, 2022

(51) Int. Cl. B25G 3/38; A47L 13/258

(52) U.S. Cl. CPC B25G 3/38; A47L 13/258

(57) ABSTRACT

A cleaning device has a handling section, a neck section, and a cleaning section. In an exemplary cleaning device, the neck section may be interconnected to the handling section and the cleaning section interconnected to the neck section. An exemplary cleaning section may have a frame that is rotatably interconnected to the neck section and configured to completely rotate about an axis of a joint between the neck section and the frame. The frame also has at least one flexible structure to engage a cover to be held in tension about the frame.

### FIELD OF THE INVENTION

Disclosed are embodiments of the invention that relate to, among other things, a cleaning apparatus with more flexibility in movement, such as may be in the form of a mop.

### BACKGROUND

Current cleaning products in the form of mops use only one side of the cleaning surface for removing debris from a floor or other surface structure. These devices require re-usable cleaning surfaces in conjunction with the mop that will need to be disposed once the surface in contact with the floor is sufficiently used so as to no longer perform a cleaning function.

During cleaning, re-usable cleaning sheets or covers may come loose and inhibit the user's ability to effect a cleaning operation. Re-attachment to anchoring points on the device can be cumbersome and time consuming and is not desirable as it would subject the user to touching the unclean surfaces of the cleaning sheet or cover.

### SUMMARY OF THE INVENTION

An exemplary cleaning device may comprise a handling section, a neck section interconnected to the handling section, and a cleaning section comprising a frame. An exemplary frame of an exemplary cleaning device may be rotatably interconnected to the neck section so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure to engage a cover configured to be disposed on the frame. In an exemplary embodiment, the frame may also have a plurality of treads coupled thereto.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure to engage a cover configured to be disposed on the frame. In an exemplary embodiment, the frame may also have a plurality of treads coupled thereto. Further, the cover is disposed on the frame via the plurality of treads.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure to engage a cover configured to be disposed on the frame. In an exemplary embodiment, the frame may also have a plurality of treads coupled thereto via the at least one flexible structure.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure, such as one or more spring-activated latches, to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure, such as one or more spring-activated latches pivotally mounted to the frame, to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow disposed in both the neck and handling sections so that the frame may completely rotate about an axis of a joint between the neck section and the frame. Additionally, an exemplary frame may also have at least one flexible structure, such as one or more flexible hooks, to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow with at least three radii so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow with at least three equal radii so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section via an elbow with at least one 90-degree angle so that the frame may completely rotate about an axis of a joint between the neck section and the frame. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section so that the frame may completely rotate about an axis substantially orthogonal with respect to a central axis of the handling section. Additionally, an exemplary frame may also have at least one flexible structure to engage a cover configured to be disposed on the frame.

An exemplary cleaning device may comprise a handling section, a neck section interconnected to the handling section, and a cleaning section comprising a frame. An exemplary frame of an exemplary cleaning device may be rotatably interconnected to the neck section so that the frame may completely rotate about an axis substantially orthogonal with respect to a central axis of the handling section. Additionally, an exemplary frame may also have at least one flexible structure to engage a cover configured to be disposed on the frame to hold it in tension about the frame.

### BRIEF DESCRIPTION OF THE DRAWINGS

FIG. 1 illustrates an exemplary inventive mop device according to a first embodiment.

FIG. 2 illustrates an exploded view of an exemplary inventive mop device according to a first embodiment.

FIGS. 3 and 3A illustrate an exemplary handle system for an exemplary inventive mop device and the section of that exemplary handle system identified by “A-A” in FIG. 3, respectively.

FIG. 4 illustrates an exploded view of an exemplary neck assembly according to a first embodiment.

FIG. 5 illustrates a sectional view of an exemplary inventive mop device according to a second embodiment.

FIG. 5A illustrates a sectional view of the exemplary inventive mop device illustrated in FIG. 5 along line A-A. This cross-section may be equally applicable to the cross-section of the same component illustrated in FIGS. 1, 2, 6, 7A-B, and 8.

FIG. 6 illustrates an exemplary exploded view of an exemplary head of an exemplary inventive mop device.

FIGS. 7A-B illustrate a pre-installed and post-installed view of exemplary spring-hinged latches for an exemplary head of an exemplary inventive mop device according to a second embodiment.

FIG. 8 illustrates an exemplary spring latch for an exemplary head of an exemplary inventive mop device according to a first embodiment.

FIGS. 9A-C illustrate exploded and other views of an exemplary neck assembly according to a second embodiment.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

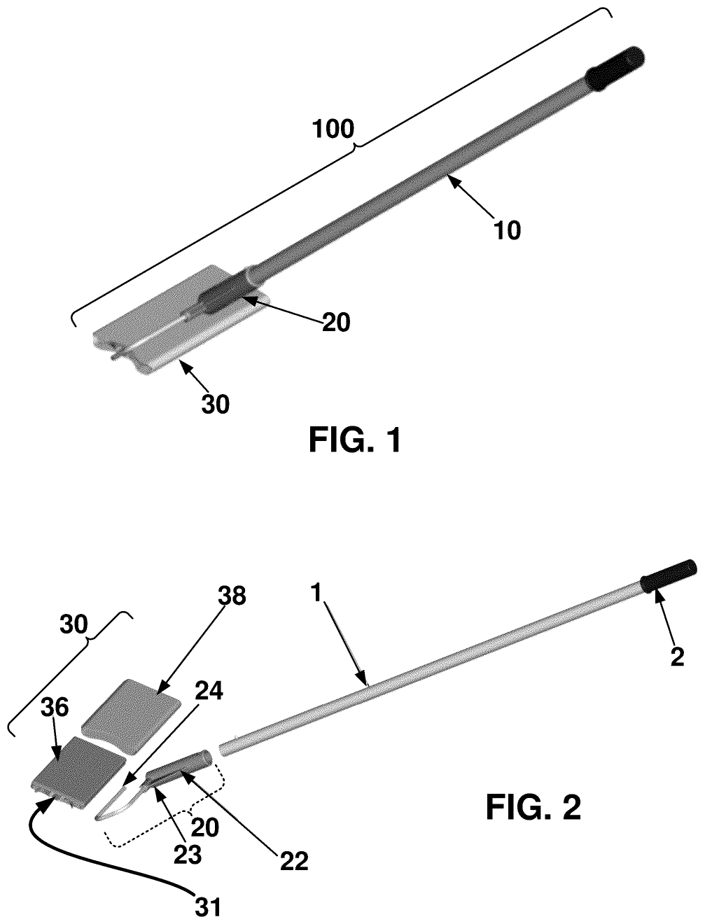

With respect to FIG. 1, a mop 100 may be shown having a handling section 10, a neck 20, and the cleaning section or “head” 30 interconnected to one another via one or a combination of mechanical, magnetic, electrical, snap-fit, welded, over-molded, permanent, and semi-permanent joining and/or fastening methods known to those skilled in the art. In an exemplary embodiment, handling section 10 may be connected to neck 20 via a snap-fit connection while head 10 may connected to neck 20 via a mechanical method such as by screws or pins. Alternatively, handling section 10 and neck 20 may be integrally-formed as a single part to reduce costs. Further alternatively, handling section 10 may be over-molded to form the neck 20 thereon, and further reduce costs for mechanical or other fastening methods otherwise needed for these two sections of an exemplary mop 100.

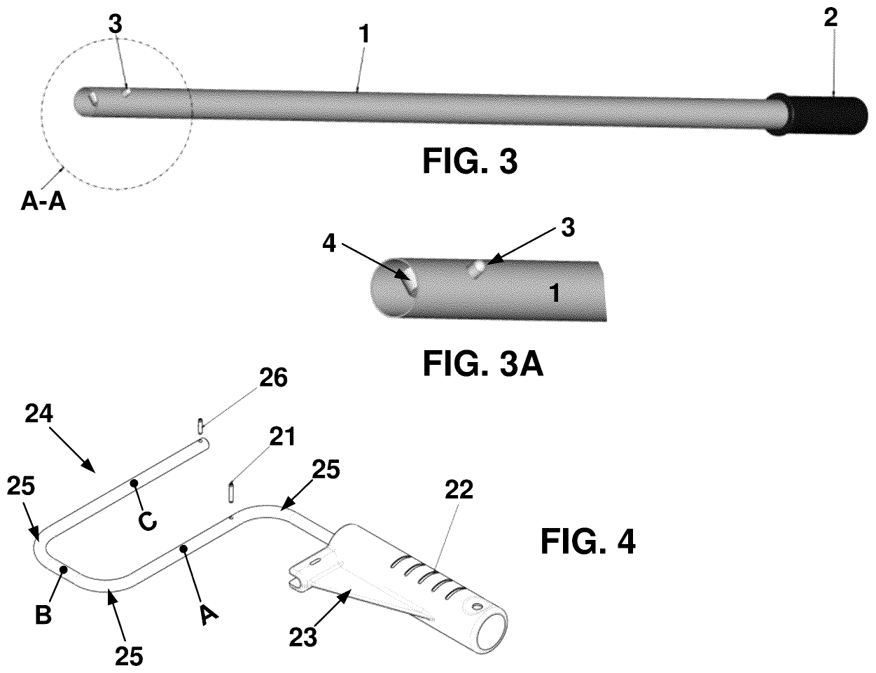

Referring to FIGS. 2-4, an exemplary handling section 10 may comprise a shaft 1 and a cap 2, which allows for covering any exposed material forming shaft 1 from the hands of a user. An exemplary cap 2 may span a minor portion to a major portion of the length of shaft 1 to enable better handling and/or gripping of the exemplary mop 100 made therefrom. In one embodiment, cap 2 may be a rubber material and in another embodiment, cap 2 may be a silicone material. Cap 2 may be made to have finger indents or palm indents to make handling of exemplary mop 100 easier on the hands of a user. Further, an exemplary cap 2 may have a rim or ridge at its furthest extent (e.g., the extent most proximal to a fastener position with a fastener 3). In an exemplary embodiment, exemplary cap 2 may be screwed onto, over-molded, or snap-fit onto one or more engaging surfaces of shaft 1. The end of shaft 1 opposite cap 2 may be configured to be inserted within a receiving orifice of mouth 22 of neck section 20 using the aforementioned fastener 3. As further illustrated in FIGS. 3 and 3A, fastener 3 may be shown in a sectional view A-A from FIG. 3 and magnified in FIG. 3A. As magnified in FIG. 3A, an exemplary fastener 3 may be a spring engagement or snap-fit mechanism using a deflectable element 4 lodged within shaft 1 to allow fastener 3 to be pushed into shaft 1 so as to be released and spring back up when an accommodating opening above fastener 3 is present, e.g., an opening in a portion of a neck section 20. While fastener 3 may be shown as a deflectable pin and spring 4 engagement, those skilled in the art may appreciate the fastener 3 may be any number of types of engagement mechanisms, such as magnetic, hook and loop, screw, friction fit, ball and socket, as well as other semi-permanent and permanent fixation methodologies. Further, it may be contemplated that shaft 1 may be comprised of multiple parts that may be assembled together or may telescope or slide within one another to elongate or shorten the length thereof.

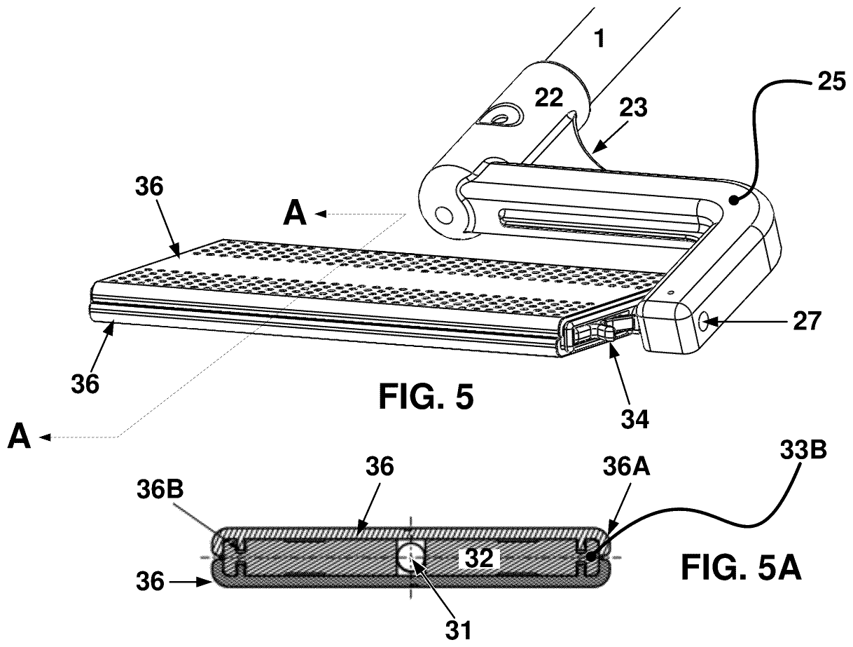

As further illustrate in FIGS. 2, 4, and 9A-C, an exemplary mouth 22 of an exemplary neck section 20 may be configured to snap-fit or be otherwise mechanically-fastened to the end of shaft 1 opposite cap 2 via the fastening mechanisms 3 and/or 4 or their mechanical equivalents known to those skilled in the art as previously described. Those skilled in the art would understand that any of the joining or fastening methods referred to previously may be employed for joining or fastening the neck section 20 to the handling section 10. The neck section 20 may further comprise a web 23 to provide rigidity and strength to the neck section 20. Further included in the neck section 20 may be an exemplary elbow 24 that may be made of the same or different material as neck 20 and/or may be permanently or removably attached to the same. In an exemplary embodiment, a pin 21 may affix elbow 24 within neck 20. In a further exemplary embodiment, web 23 may provide additional rigidity and strength to elbow 24 while being held within neck section 20. An additional rigidity enhancement of elbow 24 may be made by mechanical components or surfaces within mouth 22. An even further additional rigidity enhancement for elbow 24 may be made by mechanical components or surfaces within mouth 22 and the fastening mechanisms 3 and/or 4 within shaft 1. In other words, the combination of handling section 10 and neck section 20 may together enhance the rigidity of elbow 24. This enhanced rigidity may allow users to make better use of the exemplary mop 100 because the multiple rigidity points for elbow 24 via neck section 20 and handling section 10 may ensure that wobbling does not occur in the event any one of the rigidity points becomes loose over time. In an exemplary embodiment, an elbow 24 may be integral with mouth 22 so that a web 23 may not be necessary as the two would be one in the same material, as may be illustrated in FIG. 5A. An additional attachment pin, clip, or functionally equivalent component 26 may exist on an exemplary elbow 24 to permit attachment to the cleaning section 30 of an exemplary mop 100.

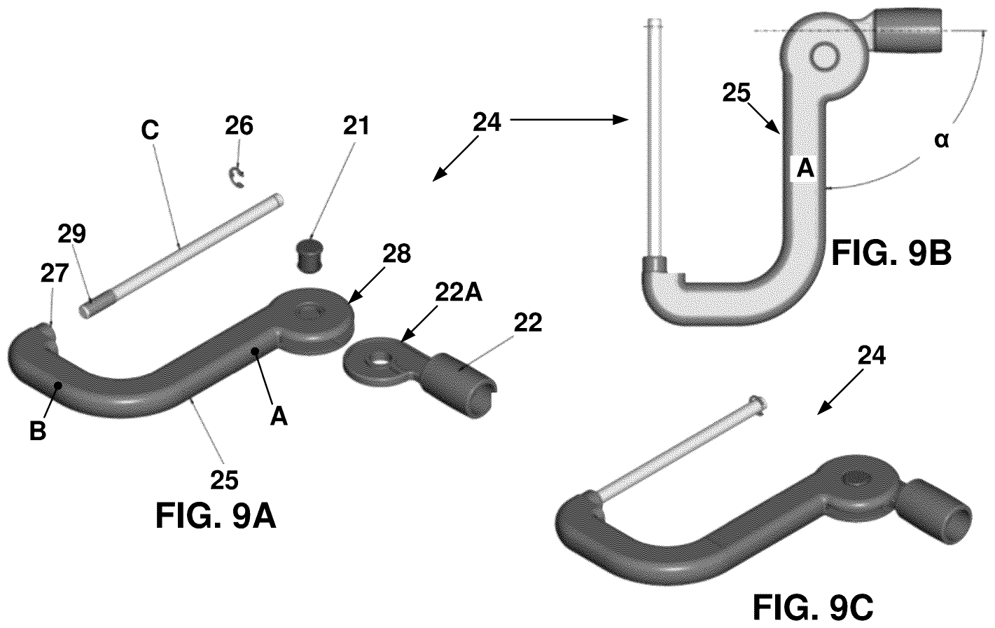

In an exemplary embodiment, an exemplary elbow 24 may have its own joinder pin or cavity 27 to attach it to an exemplary cleaning section 30 as may be illustrated in FIGS. 5 and 9A-C. While the dimensions of an exemplary elbow 24 may vary, it has been found to be especially critical in an elbow of the type illustrated in FIGS. 4 and 9A-C that the radius 25 of each bend in the elbow 24 be substantially equal. Further, exemplary section A of elbow 24 may be between 75% and 90% the length of section C of elbow 24. Further, an exemplary section B of an exemplary elbow 24 may be between 35% and 50% of either exemplary section A or exemplary section B. In a further alternative embodiment, an exemplary section B may be substantially the same length as half the width of an exemplary cleaning section 30.

In another embodiment, as may be illustratively shown via FIGS. 9A-C, an exemplary neck section 20 may have an elbow 24 comprised of a moveable mouth 22 and elbow 24 section. As illustratively provided, an exemplary mouth 22, which may be joined to the handling section 10 of an exemplary mop 100, may have a revolute joint comprised of two jaws 22A and 28 coupled to or otherwise integrally-formed with mouth 22 and elbow 24, respectively. The pin 21 previously referred to may exist as a plastic dowel or bearing that may be used to join the jaws 22A and 28 to create a neck section 20 that can fold about the axis formed by the revolute joint by a certain angle α (as shown in FIG. 9B). While the revolute joint shown in FIGS. 9A-C may appear as a simple hinge joint, those skilled in the art would understand the joint may include ball-and-socket joints, ratcheting joints, and flexibly resilient. As shown in FIG. 9A, an exemplary elbow section C may be joined to the remaining sections B and A of elbow 24 via a mechanical surface 29 that may use the cavity 27 to enable complete assembly of the full elbow 24. A finally-realized neck section 20 comprised of elbow 24 may be shown in isometric view in FIG. 9C.

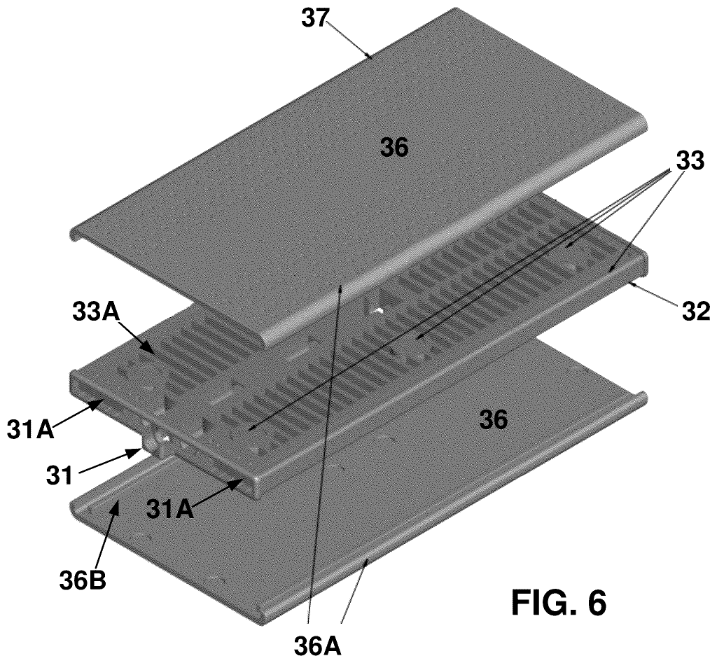

An exemplary cleaning section 30 may be illustrated in FIGS. 2, 5, 5A, and 6. According to these illustrative embodiments, an exemplary cleaning section 30 may comprise an attachment point 31, joint cavities 31A, a frame 32, one or more couplers 33, coupling regions 33A-B, capture mechanisms 34, treads 36 having underside couplers 36A-B, friction surfaces 37, and a cleaner cover 38, which in an exemplary embodiment may be disposed on one or more of the treads 36 and held thereto either via friction surface 37, capture mechanism 34, or combinations of the same. As may be illustrated in FIG. 5A, which is an exemplary cross-section of the cleaning section 30 illustrated in FIG. 5, an exemplary underside coupler 36A and 36B of tread 36 may be friction fitted to coupling region 33 B located at a peripheral region of frame 32. In an alternative embodiment, as may be illustrated in FIG. 6, an exemplary tread 36 may be coupled to frame 32 via adhesives or sonic welding between tread 36 material and one or more surface couplers 33 found within coupling region 33A, which is located inwardly of the periphery of frame 32. In a further alternative embodiment, an exemplary tread 36 may be coupled to frame 32 by a combination of couplers 33 found within coupling region 33A and a coupling region 33B. In another alternative embodiment, exemplary treads 36 may be over-molded onto frame 32 through spacing found in the coupler region 33A, as may be illustrated by the ribbing structures in frame 32 illustrated in FIG. 6.

An exemplary attachment point 31 may be any configuration of frame 32 alone or in combination with treads 36 that may hold or rigidly contain section C of the elbow 24 within the frame 32 to permit rotation about the same. In an exemplary embodiment, the pin 26 of section C of elbow 24 may be mechanically fixed in place within frame 32 upon the coupling of each tread 36 thereto. Alternatively, elbow 24 section C may be snap-fit or otherwise locked within elbow 24 before tread 36 are attached to the frame 32. Alternatively, frame 32 may be rotationally attached to elbow 24 section C via a spring hinge located where pin 26 is shown (spring not shown) to allow frame 32 to be rotated in a first direction (e.g., counterclockwise) when a force is applied to the frame via one of the neck section 20 and/or handle section 10 and be forced to rotate to a second direction (e.g., clockwise) by the spring to return to a prior orientation. In a still further embodiment, the attachment between elbow 24 section C and frame 32 may be such that frame 32 may ratchet about the elbow 24 section C so that the angle of the frame 32 may be substantially held in place about the axis of section C.

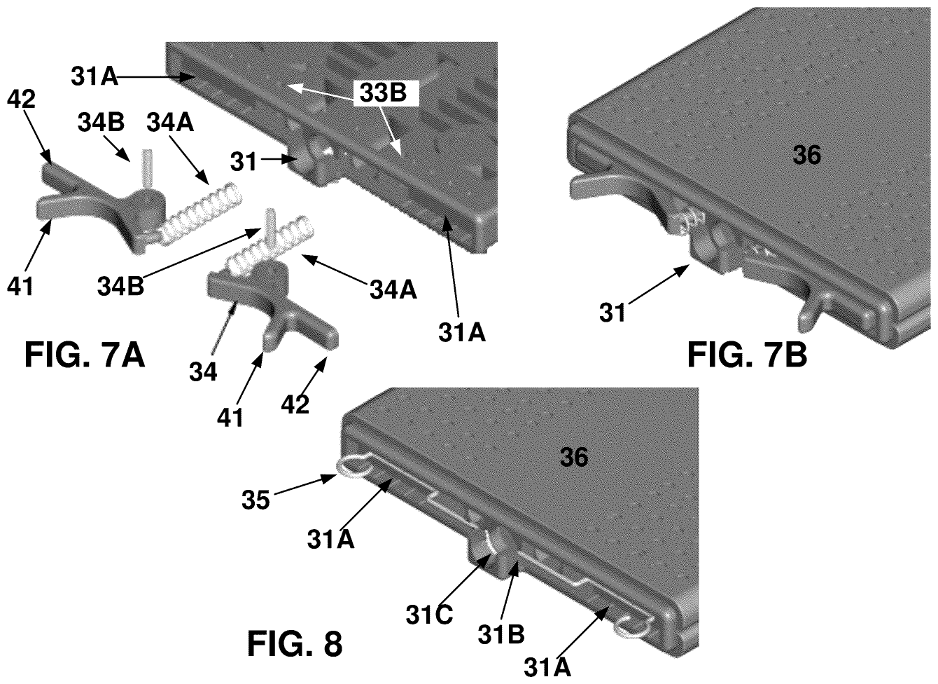

Referring to FIGS. 7A-B, an exemplary frame 32 may contain within it joint cavities 31A that may be configured to receive one or more capture mechanisms 34 to make a completed cleaning section 30 (which is shown in FIG. 7B). As may be illustrated in FIG. 7A, an exemplary cleaning section 30 may be provided in exploded view to see the assembly of each capture mechanism 34 within frame 32. An exemplary capture mechanism 34 may be coupled within frame 32 by a rotation pin 34B and elastically connected by a compression spring 34A. Each of compression spring 34A may be housed within appropriately shaped cavities 31A in the thickness of frame 32 while pin 34B may transverse an opening through peripheral coupling region 33B in frame 32. Like an exemplary pin 26, pin 34B may also be mechanically locked in frame 32 after attachment of treads 36. Alternatively, pin 34B may be fixed in frame 32 prior to attachment of treads 36 to frame 32. Further alternatively, pin 34B may be integrally molded into frame 32 such that mechanism 34 may be snapped into cavity 31A so as to be rotatable and substantially and rigidly fixed therein. This may be achieved by making the point where pin 34B would otherwise pass into mechanism 34 a hemispherical surface on either side of mechanism 34. A complementary spherical concavity within cavity 31A of frame 32 would then allow the mechanism to snap into place following placement of compression spring 34A therein. Once assembled, an exemplary capture mechanism 34 may be used by pressing against latches 41 in a direction that causes mechanism 34 to compress spring 34A within frame 32. As a result of that movement, catch 42 may rotate outwardly about the axis of pin 34B or other rotational attachment arrangement to allow it to extend away from frame 32. In an extended configuration, catch 42 may be used to clamp down upon one or more extensions from cleaner cover 38 (not shown). Alternatively, flexing of capture mechanism 34 may allow for cleaner cover 38 to envelop the treads 36 and frame 32 and, once released into a relaxed position, cause the latch 41 to hook through one or more openings in cleaner cover 38. In either embodiment, capture mechanism's flexing capabilities via springs 34A and pivot pin 34B (or like arrangement) may result in substantially rigid and/or tensioned retention of cleaner cover 38 on treads 36.

In yet another alternative embodiment, as shown in FIG. 8, an illustrative spring-hook 35 may be frictionally held within passages 31B-C in joint 31. Passages 31B-C cooperate with joint cavities 31A to house spring hook 35 so that it may be held in place while in operation. Like capture mechanism 34, spring hook 35 may be flexed to allow for capture of cleaner cover 38 so as to be held in tension around treads 36. While spring hook 35 may be shown with a circular hook terminus, any C-shaped, S-shaped, or rectangular arrangement of wire may be used at the terminus of spring hook 35 to allow for pulling the same by a user and clamping down on one or more extensions of cleaner cover 38. Alternatively, the terminus of spring hook 35 may be used to pass through openings in cleaner cover 38 to hold the same in tension about treads 36. Exemplary passages 31B-C may have friction surfaces to hold spring hook 35 in place or may themselves have clamping capabilities to hold onto spring hook 35 when in use. While passages 31B-C may be integral with the remainder of frame 32, the same may be formed as a result of the connection between elbow 24 and joint 31. In other words, the connection between elbow 24 and joint 31 may result in the rigid holding of spring hook 35 to frame 32 without use of passages 31B or 31C.

In an exemplary embodiment, the various cavities 31A and passages 31B-C found in frame 32 may be present to allow manufacturing exemplary mops 100 meant to accommodate capture mechanisms 34 and spring hooks 35.

An exemplary mop 100 may have numerous advantages by virtue of the above illustrative embodiments. In one aspect, an exemplary mop 100 may allow for one side of cleaner cover 38 to be used to clean a floor or other surface until no portion of the cover 38 remains available to take away debris. At such point, an exemplary mop 100 may allow for cleaner section 30 to flip about elbow 24 and allow the other side of cover 38 to clean the floor or other surface. In this way, a single cleaner cover 38 may be completely used on substantially all of its major sides to collect debris from the floor or other surface. When fully used, the capture mechanism 34 or spring hook 35 may be activated to release the used cover 38 so it can slide off of the treads 36 for disposal or washing. Further, the bare treads 36 may then allow the user to re-apply a new cover 38 to continue cleaning. Thus, the exemplary mop 100 may permit repeated use and replacement of covers 38 without sullying the hands of the mop 100 operator.

In another embodiment, a cleaner section 30 without cover 38 may be dipped in a soap or other cleaning solution so that any voids or pockets in frame 32 (e.g., found in or around couplers 33) may be saturated with the soap or cleaning solution. When inserted into cover 38, a saturated frame 32 may allow the soap or cleaning solution to elute into the cover 38 fiber to make for a controlled cleaning experience. In other words, unlike prior mops where all fibers are wetted with cleaning solution in an indiscriminate manner, the cover 38 of an exemplary mop may only have one wetted cleaning surface of cover 38 at a time, since the cleaning solution would operate under gravity to impregnate the fibers of the cover 38 portions in touch with the surface to be cleaned. When rotated, the other side of cover 38 may then receive any residual cleaning solution still found within frame 32 but not otherwise found within the portion of cover 38 previously in contact with the surface to be cleaned. Thus, an exemplary mop 100 may maintain at least one relatively wet portion of cover 38 in touch with the surface to be cleaned and one relatively dry portion of the same cover 38 opposite the at least one relatively wet cover 38 portion.

In yet another embodiment, the entire cleaner section 30 with cover 38 on frame 32 may be submerged in cleaning solution at the same time. Again, the exemplary mop 100 may promote use of all the cleaning solution through the portion of cover 38 in contact with the surface to be cleaned while the opposite portion of cover 38 may be relatively dryer. When flipped, any residual solution may be able to pass through frame 32 to the other cover 38 portion to continue the cleaning process. While treads 36 have been shown as solid pieces, they may be porous or have various ribs and passages to allow for liquids to pass through the same. Moreover, while the materials used to make up the various components of mop 100 have been identified, those skilled in the art may find that any component can be made from plastics, rubbers, metals, and combinations of the same. For example, exemplary treads 36 may be made from rubber or silicone while frame 32 may be a plastic, and elbow 24 a metal.

Additionally, while an exemplary cleaning section 30 may be shown as a rectangular component, those skilled in the art would understand that cleaning section 30 may be any other circle, circular (ellipsoid), or other polygonal shape provided that elbow 24 be shaped as an outline of the same to allow it to rotate in use. Thus, cleaning section 30 may comprise an octagonal frame 32 to rotate about an elbow 24 section C, while a plurality of radii 25 allow for the octagonal frame 32 to rotate freely thereby. The same is true for a circular frame 32. Further, while an exemplary mop 100 may have a cleaning section 30 having two sides of a frame 32 to act as surfaces for holding portions of a cleaner cover 38, those skilled in the art may appreciate that an exemplary mop 100 may have three or more sides to allow for numerous portions of cleaner cover 38 to be used to clean a particular surface.

In another embodiment, an exemplary cleaning section 30 may be flipped on its narrow end so that the thickness of frame 32 may be used to press against the cleaner cover 38 and thereby allow an exemplary mop 100 to fit into narrow spaces and under tight surfaces, further maximizing the cleaning capabilities of the mop 100.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A cleaning device, comprising:
a handling section;
a neck section interconnected to the handling section; and
a cleaning section comprising a frame, the frame being rotatably interconnected to the neck section, wherein the frame is configured to completely rotate about an axis of a joint between the neck section and the frame, the frame comprising at least one flexible structure to engage a cover configured to be disposed on the frame.

2. The cleaning device of claim 1, wherein the frame is rotatably interconnected to the neck section via an elbow.

3. The cleaning device of claim 2, wherein the elbow is disposed in both the neck section and the handling section.

4. The cleaning device of claim 1, wherein the frame further comprises a plurality of treads coupled thereto.

5. The cleaning device of claim 4, wherein the cover is disposed on the frame via the plurality of treads.

6. The cleaning device of claim 4, wherein the at least one flexible structure holds the cover in tension about the plurality of treads.

7. The cleaning device of claim 1, wherein the at least one flexible structure comprises at least one spring-activated latch.

8. The cleaning device of claim 7, wherein the at least one flexible structure comprises a plurality of spring activated latches.

9. The cleaning device of claim 8, wherein each of the plurality of spring activated latches is pivotally mounted to the frame.

10. The cleaning device of claim 1, wherein the at least one flexible structure comprises at least one flexible hook.

11. The cleaning device of claim 2, wherein the elbow has at least three radii.

12. The cleaning device of claim 11, wherein each of the at least three radii has the same angle of curvature with respect to the portion of the elbow that joins to the frame.

13. The cleaning device of claim 12, wherein the angle of curvature for each of the at least three radii is at least 90-degrees.

14. The cleaning device of claim 13, wherein the angle of curvature for each of the at least three radii is greater than 90-degrees.

15. The cleaning device of claim 1, wherein the frame is rotatably interconnected by a portion of the neck extending into the frame.

16. A cleaning device, comprising:
a handling section interconnected to a cleaning section, wherein the cleaning section comprises a rectilinear frame rotatably mounted to the handling section so that all sides of the frame can contact a surface to be cleaned, further wherein a cleaning cover for the cleaning section is held in tension about the frame using a surface of the frame that is orthogonal to a surface of the frame about which the cleaning cover is held in tension.

17. The cleaning device of claim 16, wherein the cleaning section is interconnected to the handling section via an elbow.

18. The cleaning device of claim 16, wherein the frame can rotate 360-degrees on an axis substantially orthogonal with respect to a central axis of the handling section.

19. The cleaning device of claim 16, wherein a spring is used to hold the cleaning cover in tension about the frame.

20. The cleaning device of claim 19, wherein a combination of the spring and a latch structure is used to hold the cleaning cover in tension about the frame.
